(19) United States
(12) Patent Application Publication
(10) Pub. No.: US 2006/0274385 A1
(43) Pub. Date: Dec. 7, 2006

(54) Imaging system for multiple document types

(75) Inventors: Robert L. Babanats, Vestavia Hills, AL (US); Howard C. Reeves, Birmingham, AL (US)

Correspondence Address: DARBY & DARBY P.C., P. O. BOX 5257, NEW YORK, NY, 10150-5257, US

(73) Assignee: Imaging Business Machines, LLC, Birmingham, AL (US)

(21) Appl. No.: 11/147,758

(22) Filed: Jun. 7, 2005

(51) Int. Cl. H04N 1/04

(52) U.S. Cl. 358/509; 358/505; 358/474

(57) ABSTRACT

A system for scanning more than one type of document, including documents on generally opaque media such as plain paper, and those on semi-transparent media such as exposed X-ray film. For scanning a document on generally opaque media, a light source in front of the document is activated as the document is scanned. For scanning a document on semi-transparent media, a light source behind the document is activate as the document is scanned. The scanning can preferably be performed at a selectable one of a plurality of resolutions. The selection of the light source and/or scanning resolution can be done automatically by detecting the type of medium of the document being processed.

### FIELD OF THE INVENTION

The present invention relates to imaging systems, particularly systems for scanning multiple types of documents.

### BACKGROUND INFORMATION

Document imaging systems such as copiers and scanners are typically designed for particular types of documents. For example, there are document imaging systems that are designed to operate on paper documents. These typically employ lighting sources which light the front side of the document as the front of the document is scanned by an imaging sensor. For typical text documents, imaging sensors with resolutions of 300 dots per inch (dpi) are commonly used.

Other imaging systems are designed to operate on transparent or semi-transparent documents such as exposed X-ray films. Such systems typically scan the front of the document as the document is illuminated from behind. For imaging of documents such as X-ray films, imaging sensors with resolutions of 600 dpi are commonly used.

### SUMMARY OF THE INVENTION

In an exemplary embodiment, the present invention provides a system that is capable of operating on a first type of document, such as plain paper documents, containing information that is viewed on a surface of the document, as well as a second type of document, such as X-ray films, containing information that is viewed through the document. In other words, with the first type of document, information is visible thereon by sensing light reflected from a surface of the document, whereas with the second type of document, information is visible thereon by sensing light passing through the document. Documents of the first type include generally opaque documents, such as those on plain paper, whereas documents of the second type include generally transparent or semi-transparent documents, such as X-ray films or the like.

Moreover, the term “document” as used herein is intended to refer to anything containing visible information on a flat medium, including paper, film, microfiche, transparencies, or the like.

In an exemplary system, the front or the back of a document is selectively illuminated as it is scanned depending on whether the document is opaque or semi-transparent.

In a further exemplary embodiment, a system is provided that can scan documents with different resolutions. For example, typical paper documents with text can be scanned at a resolution of 300 dpi whereas documents with images, such as X-ray films, can be scanned at a resolution of 600 dpi. The resolution can be selected manually by a user or automatically by the machine upon determining the document type.

In yet a further exemplary embodiment of the present invention, a system is provided that is capable of automatically determining the type of document being scanned and controlling the illumination and/or the scan resolution according to the document type.

These and other aspects of the present invention will be apparent from the following detailed description and drawings.

### BRIEF DESCRIPTION OF THE DRAWINGS

FIG. 1 is a schematic representation of an exemplary embodiment of a document imaging system in accordance with the present invention.

FIG. 2 is a schematic representation of a multiple-resolution image capturing apparatus for use in an exemplary embodiment of a document imaging system in accordance with the present invention.

### DETAILED DESCRIPTION

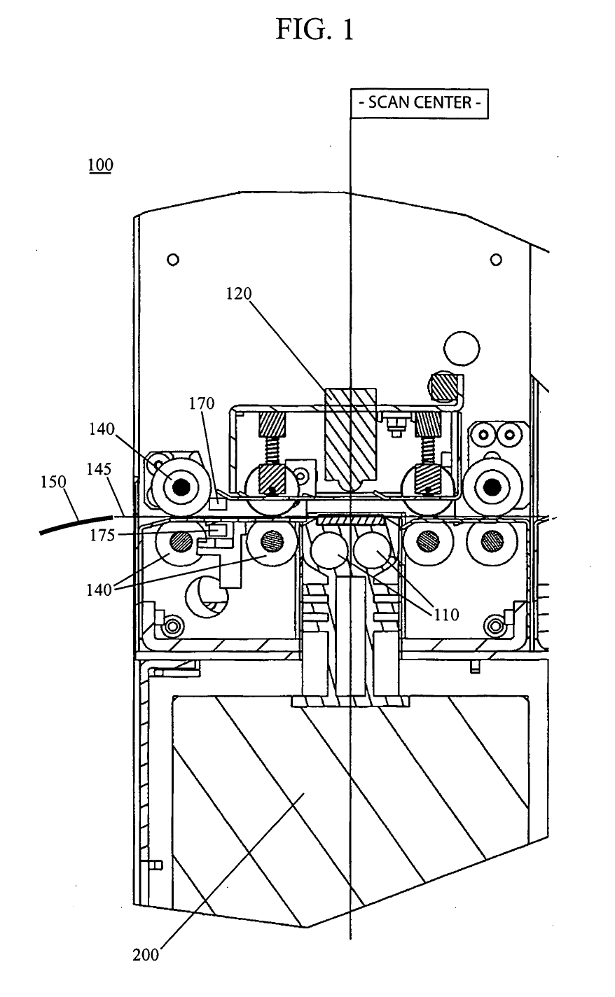

FIG. 1 shows a cross-sectional view of a portion of an exemplary embodiment of an imaging system 100 in accordance with the present invention. The system 100 comprises a document transport mechanism 140, which transports documents 150 along a document transport path 145 past light sources 110, 120 and an image capturing apparatus 200, described in greater detail below. The document transport mechanism 140 can be implemented in any of a variety of conventional ways known in the art and need not be described in greater detail. Moreover, as will be apparent, the present invention is also applicable to embodiments in which the light sources and image capturing apparatus are transported relative to a stationary document.

A first light source 110 is arranged on one side of (e.g., below) the document transport path 145 whereas a second light source 120 is arranged on the opposite side of (e.g., above) the path 145. The image capturing apparatus 200 is arranged on the same side as the first light source 110. The first light source 110 can be said to be “in front” of the document 150, whereas the second light source 120 can be said to be “behind” the document 150. The first and second light sources 110, 120 can be conventional components typically found in scanners and photocopiers. For example, the first light source 110 may be fluorescent bulbs and the second light source 120 may be a light-emitting diode (LED) array.

In the exemplary embodiment shown in FIG. 1, the first light source 110 comprises two bulbs, spaced apart to allow viewing of the document 150 by the image capturing apparatus 200 along the scan center. In alternate embodiments, it is possible for the first light source 110 to comprise one bulb, arranged off-axis of the scan center. The two-bulb embodiment shown, however, provides better illumination in cases where the document 150 is creased.

As will be appreciated, the relevant consideration for purposes of the present invention is the direction from which the document 150 is illuminated and scanned, as opposed to the physical location of the light sources 110, 120 and the image capturing apparatus 200 above or below the document 150. For instance, both light sources can be arranged above the document 150 or can be replaced by a single light source, so long as the capability exists to selectively direct light to the bottom of the document. Similarly, with the appropriate optical elements, the image capturing device 200 can be arranged on the side of the document opposite from that from which the image is captured.

In a further exemplary embodiment (not shown) two image capturing devices 200 can be used, with an image capturing device arranged on each side of the document. In this embodiment, a first light source can be used for frontal illumination for one of the image capturing devices and for rear illumination for the other image capturing device. Similarly, a second light source can be used for rear illumination for the one of the image capturing devices and frontal illumination for the other of the image capturing devices.

The light sources 110 and 120 and the image capturing apparatus 200 preferably illuminate and capture the entire width (i.e., the dimension perpendicular to the plane of FIG. 1) of the widest document that the system 100 is capable of scanning. As such, at any one time, the light sources 110 and 120 illuminate a portion (or a line) of the document 150, said portion extending the width of the document 150. At the same time, the image capturing apparatus 200 captures an image of the illuminated portion. As the document 150 is transported past the light sources 110 and 120 and the image capturing apparatus 200, it is illuminated and scanned line-by-line.

For documents 150 of the first type, such as those on plain paper, the first light source 110 is activated while the second light source 120 is disabled. For documents 150 of the second type, such as X-ray films, the second light source 120 is activated while the first light source 110 is disabled. In either case, the image capturing apparatus 200 is enabled during scanning of the document.

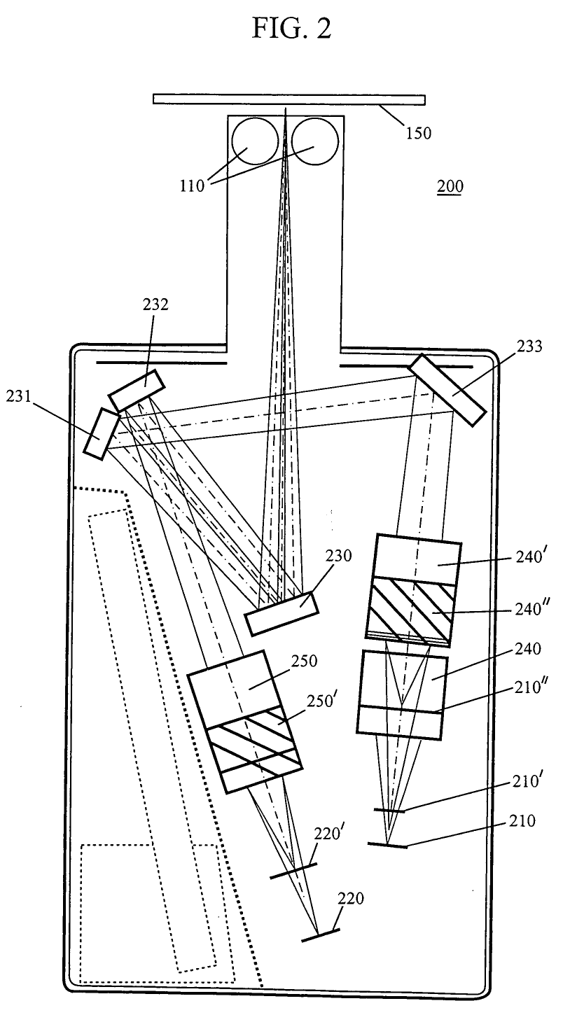

FIG. 2 shows a schematic representation of an exemplary embodiment of the image capturing apparatus 200 in greater detail. The exemplary embodiment of the image capturing apparatus 200 is capable of scanning documents with different resolutions. The apparatus 200 comprises two or more image sensors 210, 220 of different resolutions. In the exemplary embodiment shown, charge coupled devices (CCDs) are used as the sensors 210, 220, with resolutions, respectively of 300 and 600 dpi.

The image of the document 150 that is being detected by the apparatus 200 is directed to the sensors 210, 220 simultaneously by an arrangement of mirrors 230-233. The image enters the apparatus 200 and is reflected by a first mirror 230 to mirrors 231 and 232. Mirror 231 reflects the image unto a further mirror 233 which, in turn, reflects the image to a lens 240. The lens 240 focuses the image onto the surface of the sensor 210 where it is detected.

At the same time, mirror 232 reflects the image to a lens 250 which focuses the image onto the surface of the sensor 220, where it is detected.

The signal output of one of the sensors 210 or 220 can be selected depending on the desired scan resolution. This selection can be done in a variety of known ways, including by enabling or powering the desired sensor and disabling or turning off the other sensor. The selected sensor output is channeled to image processing circuitry (not shown) for processing.

Each of the sensors 210, 220 can be selected to be one of several resolutions. The sensors 210 and 220 can have the same resolution, but can be used to provide scanning of different resolutions depending on their position, as shown in FIG. 2. In the exemplary embodiment shown in FIG. 2, the sensor 210 can be placed at sensor position 210′ or placed at sensor position 210″. In exemplary embodiments, the sensor placed at sensor position 210′ provides a resolution of 500 dpi and the sensor placed at sensor position 210″ provides a resolution of 200 dpi. The corresponding lenses for sensors placed at sensor positions 210′ and 210″ are shown as 240′ and 240″, respectively. Similarly, the sensor 220 can be placed at sensor position 220′. In an exemplary embodiment, the sensor placed at sensor position 220′ provides a resolution of 300 dpi. The corresponding lens for the sensor placed at sensor position 220′ is shown as 250′.

As such, a wide variety of combinations of scanning resolutions is possible with the exemplary image capturing apparatus 200 shown in FIG. 2. Moreover, although an embodiment with two sensors is shown, embodiments with only one sensor or three or more sensors are also possible in accordance with the present invention.

As can be appreciated, the present invention is not limited to sensors of any particular resolution or technology.

The determination of which of the light sources 110, 120 to activate can be made in a variety of ways in accordance with the present invention. Likewise, so too can the determination of which image sensor resolution to use.

In an exemplary embodiment, a determination is automatically made as to the type of document 150 that is currently being processed. For example, while exposed X-ray film is largely semi-transparent, the edges of such documents typically are optically black and will not transmit infrared (IR) radiation therethrough. Paper, however, will allow IR radiation to pass through it. In the exemplary embodiment of FIG. 1, an IR emitter 170 and an IR detector 175 are arranged across from each other on opposites sides of the transport path 145. The emitter 170 and detector 175 are preferably arranged upstream of the scan center. As a document enters the system 100, the IR emitter 170 is activated. As the front edge of the document 150 passes between the emitter 170 and detector 175, the detector 175 will either detect a significant drop in the IR radiation if the document 150 is, for example, an X-ray film, or it will detect a distinctly smaller or negligible drop if the document 150 is a paper document. By analyzing the signal output of the detector 175, a determination can thus be made as to the type of the document 150. For instance, if the signal output of the detector 175 is below a predetermined threshold, a determination can be made that that the document 150 is an X-ray film, a document of the second type. The light source 110 or 120 can be activated accordingly and/or the resolution of the scan can be selected, as discussed above.

As an alternative to using IR radiation to determine document type, other forms of radiation can be used, such as, for example, ultrasonic radiation or the like.

In a further exemplary embodiment, the emitter/detector pair 170, 175 can be eliminated and a determination of the document type can be made using a different method. In such an embodiment, when a document 150 of unknown type is processed by the system 100, the second light source 120 is initially activated. As the document 150 is advanced through the system 100, if the image capturing apparatus 200 does not detect any appreciable light through the document 150 within a first predetermined distance from the front edge of the document and then detects light within a second, larger predetermined distance from the front edge of the document, a determination can be made that the document is an X-ray film. The second light source 120 is used for the scan of the rest of the document while the first light source 110 remains off. At the same time, the output of the high resolution sensor 220 can be selected to capture the details of the X-ray film.

Conversely, if the document 150 is of the plain paper variety, the image capturing apparatus 200 will detect generally the same level of light at both the first and second predetermined distances. If that is the case, the second light source 120 will be de-activated and the first light source 110 will be activated and used for scanning the rest of the document.

In a further exemplary embodiment, semi-transparent documents such as X-ray films can be marked with indicia that allow the system 100 to determine their type. If the system 100 detects the indicia on a document that is being processed, it will enable the second light source 120 and/or use the higher resolution sensor to scan the document. The indicia may comprise images, symbols or characters.

In further exemplary embodiments, the system 100 can provide for user selection of the document type and/or resolution. Such user selection can be by any suitable input mechanism such as by a keypad or the like.

It is to be understood that while the invention has been described above in conjunction with preferred specific embodiments, the description is intended to illustrate and not to limit the scope of the invention, as defined by the appended claims. Indeed, various modifications of the invention in addition to those described herein will become apparent to those skilled in the art from the foregoing description and the accompanying figures. Such modifications are intended to fall within the scope of the appended claims.

It is further to be understood that all values are to some degree approximate, and are provided for purposes of description.

The disclosures of any patents, patent applications, and publications that may be cited throughout this application are incorporated herein by reference in their entireties.

What is claimed is:

1. A system for scanning a document, comprising:
a first light source, the first light source illuminating a first side of the document;
a second light source, the second light source illuminating a second side of the document;
an image capturing apparatus, the image capturing apparatus capturing an image of the document from the first side of the document; and
a selector, the selector selecting for activation one of the first and second light sources.

2. The system of claim 1, wherein the image capturing apparatus comprises multiple image sensors of different resolutions.

3. The system of claim 2, wherein the resolution is selected in accordance with the selector.

4. The system of claim 1, wherein the selector selects the light source in accordance with a document type.

5. The system of claim 1, comprising:
a document transport mechanism, the document transport mechanism transporting documents along a document transport path which is illuminated by at least one of the first and second light sources and which is viewed by the image capturing apparatus.

6. The system of claim 1, wherein:
the first light source is arranged on the first side of the document, and
the second light source is arranged on the second side of the document.

7. The system of claim 1, wherein:
the image capturing apparatus is arranged on the first side of the document.

8. The system of claim 4, comprising:
a radiation emitter, the radiation emitter emitting a radiation toward one of the first and second sides of the document; and
a radiation detector, the radiation detector detecting the radiation from the opposite one of the first and second sides of the document.

9. The system of claim 8, wherein the document type is determined to include an optically black portion if the radiation detected by the radiation detector is below a predetermined threshold.

10. The system of claim 9, wherein the document type is an X-ray film.

11. The system of claim 8, wherein the radiation is infrared radiation.

12. The system of claim 8, wherein the radiation is ultrasonic radiation.

13. The system of claim 2, wherein the image capturing apparatus comprises two image sensors having resolutions selected from the set of resolutions consisting of 200, 300, 500 and 600 dpi.

14. The system of claim 4, wherein the document type includes a first document type containing information that is viewed on a surface of the document and a second document type containing information that is viewed through the document.

15. The system of claim 14, wherein the first light source is activated for the first type of document and the second light source is activated for the second type of document.
